(19) United States
(12) Patent Application Publication
(10) Pub. No.: US 2023/0341705 A1
(43) Pub. Date: Oct. 26, 2023

(54) Organic Nose Pads for Eyeglasses

(71) Applicant: Wayne Chatman, Tampa, FL (US)

(72) Inventor: Wayne Chatman, Tampa, FL (US)

(21) Appl. No.: 18/176,814

(22) Filed: Mar. 1, 2023

Related U.S. Application Data
(60) Provisional application No. 63/334,738, filed on Apr. 26, 2022.

(51) Int. Cl. G02C 5/12

(52) U.S. Cl. CPC G02C 5/12

(57) ABSTRACT

The present invention relates to an organic nose pad for an eyeglass frame. The organic nose pad is configured to attach to any conventional or smart eyeglass frame and prevents slippage of the eyeglass to which the nose pad is mounted. The nose pad includes a front surface, a rear surface, and an adhesive layer or a central groove to mount the nose pad to an eyeglass frame. The nose pad has a textured surface to prevent slippage of the nose pad. The nose pad is made of a soft and flexible material that also removes oil and sweat from a user’s skin. The nose pad is commercially available in pairs to secure the eyeglasses around both sides of a user’s nose.

### CROSS-REFERENCE TO RELATED APPLICATION

The present application claims priority to, and the benefit of, U.S. Provisional Application No. 63/334,738, which was filed on April 26^{th}, 2022 and is incorporated herein by reference in its entirety.

### FIELD OF THE INVENTION

The present invention relates generally to nose pads. More specifically, the present invention relates to an organic and moisture-absorbing nose pad for eyeglasses. The nose pad adheres to an eyeglass frame using an adhesive or is attached through a groove of the eyeglass frame and receives a connector. The nose pad is made of a soft and flexible material that also removes oil and sweat from a user’s skin. The nose pad can have a plurality of shapes and sizes and has an enhanced grip to prevent slipping from a user’s nose. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, eyeglasses (both conventional and smart) are generally supported on a user’s nose via nose pads. The nose pads are mounted on the eyeglass frames and contact the user’s nose. Commercially available nose pads typically slip on a user’s skin which causes the eyeglasses to slip, which can be uncomfortable for users.

Also, people with naturally oily skin tend to have even more difficulties with keeping their eyeglasses on their face. Due to oily skin and moisture, constant slipping of nose pads and eyeglasses can occur. Thus, users need to constantly adjust their eyeglasses, which may become inconvenient and troublesome. In order to avoid constant slippage of eyeglasses, a user needs to repeatedly clean his or her face and/or nose pads which can be frustrating and time-consuming. During the cleaning process, complete removal of the eyeglasses can lead to misplacing them, and wearing eyeglass straps may not always be feasible.

Further, conventional nose pads may not conform to the shape of a user’s nose and can be of a relatively hard material. The nose pad may dig into a user’s nose, causing an indentation on the nose, which may cause irritation and discomfort to the user. Also, current nose pads do not absorb sweat and oil, but rather promote additional sweating around a user’s nose.

Therefore, there exists a long felt need in the art for nose pads that prevent the constant slippage of eyeglasses. There is also a long felt need in the art for nose pads that are suitable for use by users having oily skin. Additionally, there is a long felt need in the art for nose pads that properly conform to a user’s nose and are soft in structure. Moreover, there is a long felt need in the art for nose pads that can be integrated into eyeglasses during manufacturing or used as an attachment to existing eyeglasses. Finally, there is a long felt need in the art for nose pads that prevent eyeglass slippage, maximize stability on a user’s face and remove oil and sweat from a user’s skin.

The subject matter disclosed and claimed herein, in one embodiment thereof, comprises an organic nose pad for an eyeglass frame. The organic nose pad is configured to attach to any conventional or smart eyeglass frame. The nose pad further comprises a front surface and a rear surface. The rear surface comprises an adhesive layer to attach the nose pad to the eyeglass frame and the front surface has a textured surface to prevent slipping of the nose pad. The nose pad is made of a soft and flexible material that also removes oil and sweat from a user’s skin.

In this manner, the novel nose pad of the present invention accomplishes all of the forgoing objectives, and provides a relatively cost-effective, easy and convenient solution to eliminating the constant slippage of eyeglasses while absorbing sweat and oil near a user’s nose area. The nose pad is comfortable for a user and can attach/mount to an eyeglass using adhesive or any other suitable means. The grip-textured and curved surface area of the nose pad provides the necessary comfort and security for user’s when wearing eyeglasses. The nose pad eliminates the need to constantly adjust a user’s eyeglasses.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an organic nose pad device. The organic nose pad device is configured to attach to an eyeglass frame. The nose pad device comprises a front surface and a rear surface. The rear surface comprises an adhesive layer to attach the nose pad to the eyeglass frame and the front surface comprises a textured surface to prevent slippage of the nose pad device on a user’s face.

In yet another embodiment of the present invention, an organic nose pad device is disclosed. The nose pad device includes a rear surface and a front surface. The rear surface has an adhesive layer and the front surface has a depression at a center point, thus configuring the nose pad device in a convex shape. Further, the nose pad device comprises a plurality of soft rubber or silicon protrusions on a portion of the front surface for allowing the nose pad device to grip to a user’s nose to prevent slippage. The rear surface and the front surface are integrally molded to form a single piece structure.

In yet another embodiment of the present invention, an improved nose pad device is disclosed. The nose pad device includes a groove at the center that is configured to receive a connector or a screw to attach the nose pad to an eyeglass, wherein the connector or screw is pushed into the groove. Further, the nose pad device is thin and can have an oval shape, D-shape, tear drop shape, round shape, etc. The nose pad device also has a textured surface to grip to a user’s nose to prevent slippage of the nose pad device.

In a further embodiment of the present invention, a convex-shaped nose pad device is disclosed. The nose pad device has a rear surface to attach to an eyeglass frame, and a front surface to adhere to a user’s nose. The front surface has a depression at the center to provide comfort to a user while wearing the eyeglass frame for a long period of time.

In a further embodiment of the present invention, the nose pad device is manufactured of one or a combination of organic materials, such as soft surgical grade silicone, pacifier grade silicone, soft rubber, polycarbonate, and poly-vinyl chloride, etc. Further, the nose pad device absorbs moisture and oil from a user’s skin and can be easily cleaned using water or alcohol.

In yet another embodiment of the present invention, a single-piece nose bridge structure which attaches to an eyeglass is disclosed. The nose bridge structure has an exterior surface including a right exterior surface, a left exterior surface and a U-shaped exterior surface that is configured to adhere to an eyeglass frame. The nose bridge structure also includes an interior surface including a right interior surface, a left interior surface and a U-shaped interior surface that is configured to rest on a user’s nose.

In yet another embodiment of the present invention, the nose pad device or nose bridge structure can be used with conventional or smart eyeglasses. The nose pad device or nose bridge structure can be integrated into eyeglasses during manufacturing, and can also be marketed as an aftermarket product. The surface material absorbs moisture and oils and prevents eyeglass slippage to maximize stability on a user’s nose.

The nose pad device is commercially available in pairs to secure eyeglasses around both sides of a user’s nose. Commercially, the nose pad device can be available in five pairs of nose pads, ten pairs of nose pads, twelve pairs of nose pads or twenty four pairs of nose pads, etc.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the organic nose pad device of the present invention for use with eyeglasses in accordance with the disclosed architecture;

FIG. 2 illustrates a perspective view of one potential embodiment of the organic nose pad device of the present invention attached to an eyeglass in accordance with the disclosed architecture;

FIG. 3 illustrates a perspective view of another potential embodiment of the organic nose pad device of the present invention with depressions in accordance with the disclosed architecture;

FIG. 4 illustrates a perspective view of yet another potential embodiment of the organic nose pad device of the present invention with rubber protrusions in accordance with the disclosed architecture;

FIG. 5 illustrates a perspective view showing yet another potential embodiment of the organic nose pad device of the present invention with U-shaped surfaces in accordance with the disclosed architecture; and

FIG. 6 illustrates a perspective view showing yet another potential embodiment of the organic nose pad device of the present invention attached to an eyeglass frame in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for nose pads that prevent constant slippage of eyeglasses. There is also a long felt need in the art for nose pads that are suitable for use by users having oily skin. Additionally, there is a long felt need in the art for nose pads that properly conform to a user’s nose and are soft in structure. Moreover, there is a long felt need in the art for nose pads that can be integrated into eyeglasses during manufacturing, or used as an attachment to an existing pair of eyeglasses. Finally, there is a long felt need in the art for nose pads that prevent eyeglass slippage, maximize stability on a user’s face, and remove oil and sweat from a user’s skin.

The present invention, in one exemplary embodiment, is a novel organic nose pad device. The nose pad device is a single unit structure and comprises a rear surface and a front surface. The rear surface has an adhesive layer and the front surface has a depression at a center point, thereby giving the nose pad device a convex shape. Further, a plurality of soft rubber or silicon protrusions are positioned on a portion of the front surface, which allow the nose pad device to grip a user’s nose and prevent slippage. The nose pad device can be manufactured in a plurality of shapes such as elliptical, oval, D-shaped, round, etc.

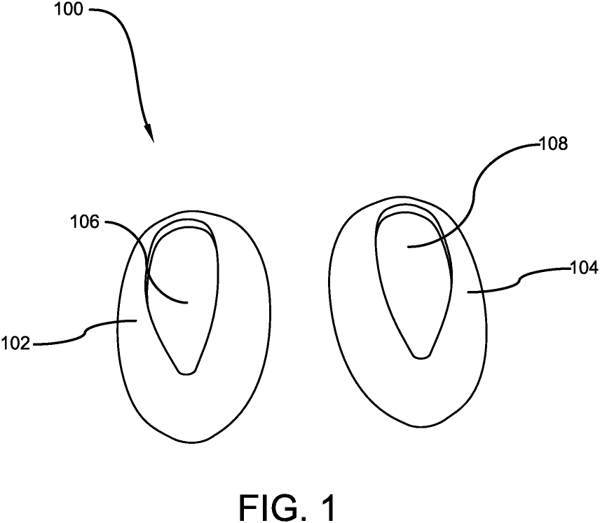

Referring initially to the drawings, FIG. 1 illustrates a perspective view of one embodiment of the organic nose pad device of the present invention for a pair of eyeglasses. The organic nose pad devices 100 are typically used in pairs and are configured to be detachably-connected to an inner side of an eyeglass frame near the nose portion, such that they are positioned on a left side and a right side of a user’s nose. The organic nose pad devices 100 can be used with both normal and smart eyeglasses, or any other suitable eyeglasses or sunglasses known in the art.

The pair of organic nose pad devices 100 includes a first organic nose pad device 102 for a left side of a user’s nose and a second organic nose pad device 104 for a right side of a user’s nose. The nose pad devices 102, 104 are typically configured to be oval in shape, but can be configured in any other suitable shape as is known in the art, such as a D-shape, tear drop shape, round shape, etc. The first nose pad device 102 comprises a groove or depression 106 for receiving a connector head or a screw head to fasten the first nose pad device 102 to an inner surface of the eyeglass frame. Similarly, the second nose pad device 104 comprises a second groove or depression 108 for receiving a connector head or a screw head to fasten the second nose pad device 104 to an inner surface of the eyeglass frame. The grooves or depressions 106, 108 can be any suitable shape or size known in the art, such as an oval shape, D-shape, tear drop shape, round shape, etc. Utilizing the grooves 106, 108, the nose pad devices 102, 104 are then pushed into the connector head or screw head and secured to mount the nose pad devices 102, 104 to the inner surface of the eyeglass frame around the nose portion of the eyeglasses.

The nose pad devices 102, 104 are manufactured of a slightly flexible and soft material such as organic soft surgical grade silicone, pacifier grade silicone, etc., or any other suitable material as is known in the art, such that the nose pad devices 102, 104 can be adjusted on a user’s nose per the wants and/or needs of a user. The nose pad devices 102, 104 absorb moisture and oils from a user’s nose and prevent eyeglass slippage. The nose pad devices 102, 104 can further have a textured surface which allows the nose pad devices 102, 104 to grip a user’s skin and thus maximize stability. The nose pad devices 102, 104 are suitable for various kinds of eyeglasses, sunglasses, spectacles, etc., and are suitable for all kinds of plate optical frames, board sunglass plates, plastic frames, etc., or any other suitable frames as is known in the art.

The nose pad devices 102, 104 of the present embodiment are commercially available in a package of five pairs, six pairs, twelve pairs, etc., or any other suitable number of nose pad devices 102, 104 as is known in the art. The nose pad devices 102, 104 can come in various colors such as transparent, translucent or any other suitable color known in the art, to match with a user’s eyeglasses, sunglasses, eye color, etc.

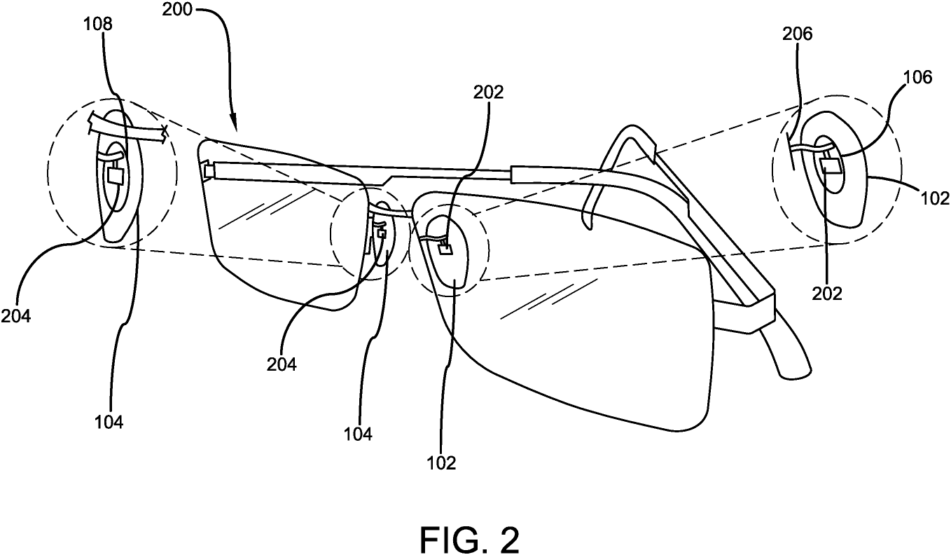

FIG. 2 illustrates a perspective view showing another embodiment of the organic nose pad device of the present invention attached to an eyeglass frame. To secure and attach the first nose pad device 102 to the eyeglass frame 200, the groove 106 is pushed into a connector head or screw head 202 that is attached to an inner surface 206 of the eyeglass frame 200. Specifically, the connector head 202 form fits into the groove 106 allowing a secure and stable attachment of the first nose pad device 102 to the inner surface 206 of the eyeglass frame 200. Once secure, the first nose pad device 102 can be adjusted in direction and position, as per the wants and/or needs of a user. Similarly, to attach the second nose pad device 104 to the eyeglass frame 200, the second groove 108 is pushed into a second connector head or screw head 204 that is attached to an inner surface 206 of the eyeglass frame 200. Specifically, the second connector head 204 form fits into the second groove 108 allowing a secure and stable attachment of the second nose pad device 104 to the inner surface 206 of the eyeglass frame 200. Once secure, the second nose pad device 104 can be adjusted in direction and position as per the wants and/or needs of a user.

The nose pad devices 102, 104 can also have extra cushioning on their surfaces to improve the supporting force, and reduce the weight of the eyeglass frame 200 as felt by a user, thus reducing a user’s discomfort during periods of long wear. The eyeglass frame 200 can achieve the desired balance as required by a user by using the organic nose pad devices of the present embodiment.

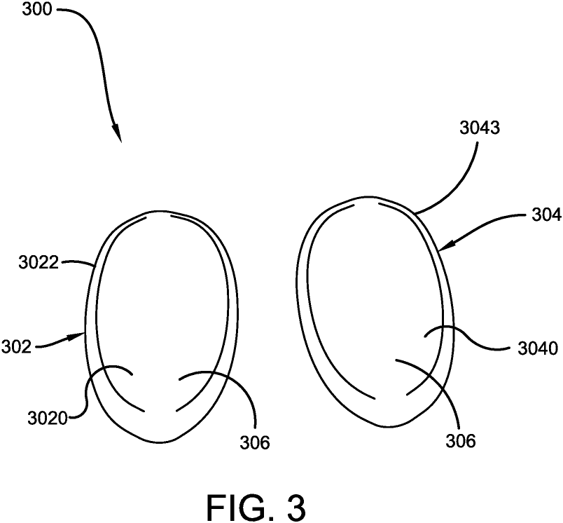

FIG. 3 illustrates a perspective view of another embodiment of the organic nose pad device of the present invention with depressions. In the present embodiment, the organic nose pads are a pair of adhesive-based organic nose pad devices 300. The pair of organic nose pad devices 300 comprise a first adhesive nose pad device 302 and a second adhesive nose pad device 304. The first adhesive nose pad device 302 has a front surface 3020 that touches a user’s skin during use and a rear surface 3022 which comprises an adhesive layer to adhere to an inner surface of an eyeglass frame. The second adhesive nose pad device 304 has a front surface 3040 that touches a user’s skin during use and a rear surface 3043 which comprises an adhesive layer to adhere to an inner surface of an eyeglass frame. The adhesive layer for both nose pad devices 302, 304 can be any suitable adhesive known in the art which would securely adhere the rear surfaces 3022, 3043 of the nose pad devices 302, 304 to the inner surfaces of the eyeglass frame.

The pair of nose pad devices 300 can be of any suitable size or shape comfortable to a user, such as an oval shape, D-shape, tear drop shape, round shape, etc., or any other geometrical shape known in the art. Each adhesive nose pad device 302, 304 comprises a depression 306 in the front surface 3020, 3040 allowing the nose pad devices 302, 304 to conform to the curvature of a user’s nose. The load of the eyeglass frame and lenses is distributed across the complete nose pad device 302, 304 thus providing comfort to a user. Accordingly, the eyeglass frame and lenses are comfortable to wear, and the nose pad devices 302, 304 can be used for a long time. Further, the adhesive nose pad devices 302, 304 are easy to handle due to the depression 306 at the center.

The rear surface 3022, 3043 of each nose pad device 302, 304 can be more rigid in comparison to the front surface 3020, 3040. In a preferred embodiment, each nose pad device 302, 304 is a single-piece structure. Alternatively, the rear surface 3022, 3043 and the front surface 3020, 3040 of each nose pad device 302, 304 can be manufactured of a separate material, and can then be integrally molded to form the nose pad devices 302, 304.

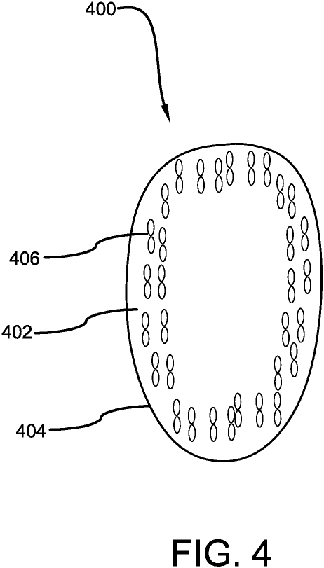

FIG. 4 illustrates a perspective view of another embodiment of the organic nose pad device of the present invention with a plurality of rubber protrusions. In the present embodiment, the front surface 402 of the nose pad device 400 comprises a plurality of soft rubber or silicon protrusions 406, etc., or any other suitable material as is known in the art which allows the nose pad device 400 to conform to a user’s oily skin to prevent slippage of the eyeglasses worn by a user. The soft rubber protrusions 406 can be of any suitable size or shape or number based on the needs and/or wants of a user. Also, the rear surface 404 of the nose pad device 400 comprises an adhesive layer to adhere the nose pad device 400 to an inner surface of an eyeglass frame. The rear surface 404 and the front surface 402 of the nose pad device 400 can be manufactured of separate materials and then integrally molded to form the nose pad device 400.

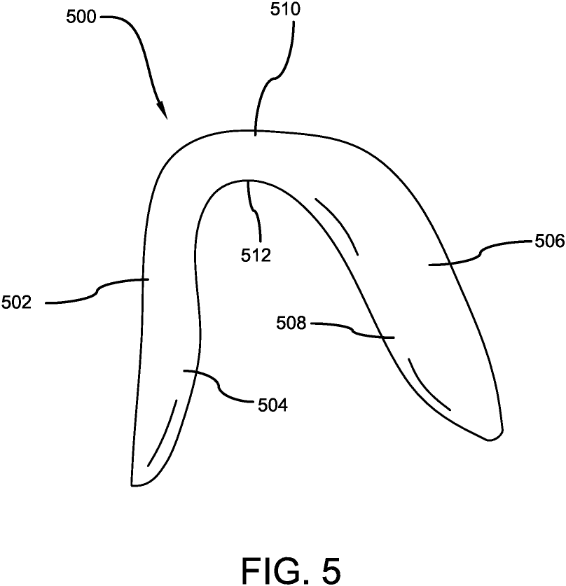

FIG. 5 illustrates a perspective view showing another embodiment of the organic nose pad device of the present invention with a U-shaped surface. The nose pad device of the present invention is a one-piece nose bridge structure 500 for conforming around a bridge of a user’s nose. The nose bridge structure 500 is made up of soft rubber or silicon, etc., or any other suitable material as is known in the art that is slightly flexible to conform to the contour of a user’s nose. The nose bridge structure 500 comprises a right exterior surface 502 to adhere to an eyeglass frame, a right interior surface 504 to contact the right side of a user’s nose, a left exterior surface 506 to adhere to an eyeglass frame, a left interior surface 508 to contact the left side of a user’s nose, a U-shaped exterior surface 510 to adhere to an eyeglass frame and a U-shaped interior surface 512 to contact the bridge of a user’s nose. The nose bridge structure 500 grips a user’s skin to prevent slippage of the eyeglasses. The right exterior surface 502, the left exterior surface 506, and the U-shaped exterior surface 510 all have an adhesive layer to adhere the nose bridge structure 500 to an eyeglass frame.

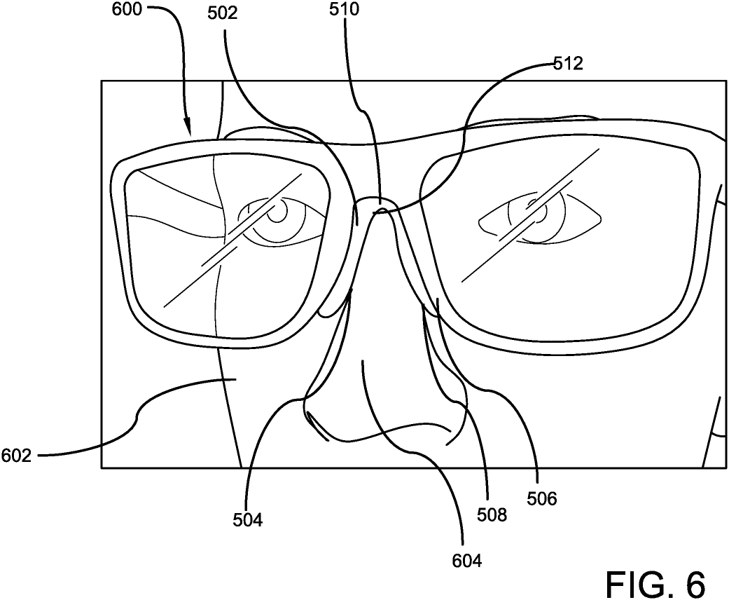

FIG. 6 illustrates a perspective view showing another embodiment of the organic nose pad device of the present invention attached to an eyeglass frame. As shown, the one-piece nose bridge structure 500 is secured to an eyeglass frame 600 using adhesive on the exterior surfaces 502, 506, 510. The interior surfaces 504, 508, 512 contact the nose 604 of the user 602, and the grip-texture and curved surface area of the interior surfaces 504, 508, 512 maintain comfort and a secure position on a user’s nose 604. Further, the interior surfaces 504, 508, 512 of the nose bridge structure 500 are manufactured of a material which absorbs moisture, sweat and oils from a user’s skin to further prevent slippage.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “pair of nose pad devices”, “organic nose pad devices”, “pair of adhesive based organic nose pad devices”, “adhesive based organic nose pad devices”, and “pair”, are interchangeable and refer to the pair of nose pad devices 100 of the present invention. Additionally, “one-piece nose bridge structure”, “nose pad bridge” and “nose bridge”, are interchangeable and refer to the one-piece nose bridge structure 500 of the present invention

Notwithstanding the forgoing, the nose pad devices 100, 300, 400, 500 of the present invention can be of any suitable size and configuration as is known in the art without affecting the overall concept of the invention, provided that it accomplishes the above stated objectives. One of ordinary skill in the art will appreciate that the size, configuration, and material of the nose pad devices 100, 300, 400, 500 as shown in FIGS. 1-6 are for illustrative purposes only, and that many other sizes and shapes of the nose pad devices 100, 300, 400, 500 are well within the scope of the present disclosure. Although the dimensions of the nose pad devices 100, 300, 400, 500 are important design parameters for user convenience, the nose pad devices 100, 300, 400, 500 may be of any size that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An organic nose pad device configured for attachment to an inner surface of an eyeglass frame near a nose portion, the organic nose pad device comprising:
a front surface that contacts a user’s skin during use; and
a rear surface that attached to the inner surface of an eyeglass frame, wherein the organic nose pad device is comprised of a soft surgical grade silicone to absorb moisture and oil from a user’s nose and prevent slippage of the eyeglass frame from the user’s skin.

2. The organic nose pad device of claim 1, wherein a first organic nose pad device is secured to a left side of a user’s eyeglass frame and a second organic nose pad device is secured to a right side of a user’s eyeglass frame.

3. The organic nose pad device of claim 2, wherein the first organic nose pad device and the second organic nose pad device are oval in shape.

4. The organic nose pad device of claim 1, wherein the rear surface comprises a groove for receiving a connector head to fasten to the eyeglass frame.

5. The organic nose pad device of claim 4, wherein the groove is pushed into the connector head and secured to mount the organic nose pad device to the eyeglass frame.

6. The organic nose pad device of claim 1, wherein the rear surface comprises an adhesive layer.

7. The organic nose pad device of claim 1, wherein the front surface comprises a textured surface to grip a user’s skin.

8. The organic nose pad device of claim 1, wherein the front surface comprises cushioning to increase comfort.

9. The organic nose pad device of claim 1, wherein the front surface comprises a depression in the front surface allowing the organic nose pad device to conform to a curvature of a user’s nose.

10. The organic nose pad device of claim 1, wherein the front surface comprises a plurality of rubber protrusions to prevent slippage.

11. The organic nose pad device of claim 1, wherein the organic nose pad device is configured as a one-piece structure.

12. The organic nose pad device of claim 1, wherein the front surface and the rear surface are manufactured of separate material and integrally molded together.

13. A nose bridge structure configured to conform around a bridge of a user’s nose, the nose bridge structure comprising:
a right exterior surface to adhere to an eyeglass frame;
a right interior surface to contact a right side of a user’s nose;
a left exterior surface to adhere to an eyeglass frame;
a left interior surface to contact a left side of a user’s nose;
a U-shaped exterior surface to adhere to an eyeglass frame; and
a U-shaped interior surface to contact a bridge of a user’s nose, wherein the nose bridge structure is manufactured of soft surgical grade silicone to absorb moisture and oil from a user’s nose and prevent slippage.

14. The nose bridge structure of claim 13, wherein the nose bridge structure is configured as a one-piece structure.

15. The nose bridge structure of claim 13, wherein the right exterior surface, the left exterior surface, and the U-shaped exterior surface comprise an adhesive layer to adhere the nose bridge structure to an eyeglass frame.

16. The nose bridge structure of claim 13, wherein the right interior surface, the left interior surface, and the U-shaped interior surface comprise a grip-textured surface to prevent slippage.

17. The nose bridge structure of claim 16, wherein the right interior surface, the left interior surface, and the U-shaped interior surface comprise a curved surface area to conform to contours of a user’s nose.

18. A pair of nose pad devices each configured for attachment to an inner side of an eyeglass frame near a nose portion, the pair of nose pad devices comprising:
a first organic nose pad device comprising a front surface and a rear surface and secured to a left side of a user’s eyeglass frame; and
a second organic nose pad device comprising a front surface and a rear surface and secured to a right side of a user’s eyeglass frame; and
wherein each front surface comprises a depression to allow the pair of nose pad devices to conform to a curvature of a user’s nose; and
wherein each rear surface comprises an adhesive layer to secure to an inner surface of an eyeglass frame; and
wherein the pair of nose pad devices are manufactured of soft surgical grade silicone to absorb moisture and oil from a user’s nose and prevent slippage therefrom.

19. The pair of nose pad devices of claim 18, wherein each front surface comprises a plurality of rubber protrusions to prevent slippage.

20. The pair of nose pad devices of claim 18, wherein the pair of nose pad devices are configured as a one-piece structure.
